(19) United States
(12) Patent Application Publication
(10) Pub. No.: US 2021/0143977 A1
(43) Pub. Date: May 13, 2021

(54) METHOD FOR ENCODING, TRANSMITTING AND/OR STORING AND DECODING DIGITAL INFORMATION IN AN UNBREAKABLE MANNER

(71) Applicant: I & G TECH S.A.S. DI AMADIO GIANCARLO & C., Milano (IT)

(72) Inventor: Giancarlo AMADIO, Milano (IT)

(73) Assignee: I & G TECH S.A.S. DI AMADIO GIANCARLO & C., Milano (IT)

(21) Appl. No.: 17/257,065

(22) PCT Filed: Jul. 2, 2019
(86) PCT No.: PCT/IB2019/055639

§ 371 Date: Dec. 30, 2020

(30) Foreign Application Priority Data
Jul. 4, 2018 (IT) 102018000006911

(51) Int. Cl. H04L 9/06

(52) U.S. Cl. CPC H04L 9/0618

(57) ABSTRACT

A method comprising: providing a basic digital sequence organized as a sequence of bit packets, in which each bit packet is characterized by a respective position in the sequence and corresponds to an alphanumeric or special digital character of a given digital representation; encoding digital information based on the basic digital sequence by an encryption process comprising the steps of encoding the alphanumeric or special characters of the information to be encoded, based on a processing of the positions in which they are present, in the basic digital sequence, so that a subsequent processing of a digital sequence of positional information indicates the way in which to reconstruct the alphanumeric or special characters of the information previously encoded; the digital sequence of positional information in combination with the basic digital sequence being adapted to reconstruct the encoded digital information; decoding digital information received to obtain the respective encoded digital information.

### BACKGROUND OF THE INVENTION

### Scope of Application

The present invention relates to the technical field of encoding, transmission and decoding of digital information by digital electronic processing.

In particular, the invention relates to a method for encoding, transmitting and/or storing and decoding digital information in an unbreakable manner.

It is the first time that an unbreakable digital transmission system has been created.

The system will most likely change all digital, telephone, internet communications, at a global level, being the only one that guarantees total security during transmission or storage until the basic digital sequence and the sequence containing the processing of the positions of the basic sequence are not both available for the reconstruction of the original message.

### Description of the Prior Art

To highlight the change, encryption systems called Transport Layer Security (TLS) and its predecessor Secure Sockets Layer (SSL) are currently used, with keys up to 4906 bits to make transmission secure. A tls or ssl system with a billion-bit key should be less secure than the method described below.

Briefly, many methods of digital data encoding are known, by electronic processing, aiming at the function of protecting the content of such data and preventing the intelligibility of the data, even in the case in which they were “physically” intercepted by a person or entity not authorized or other than the recipient.

This area comprises for example encryption and decryption techniques of each individual digitized character of a message, and/or encoding and decoding techniques operating on digital objects corresponding to higher semantic levels (for example, a word), and/or encryption techniques for encrypting and decrypting digital data.

In the context of this description, the term “encoding” (and, likewise “decoding”) will be used as a more general term to define all the procedures mentioned above.

In the most common known solutions, the encoding/decoding is based on two essential parts: an encoding/decoding algorithm, and a “key”, that is, information which, combined with the “unencrypted” text passed through the algorithm, generates the encoded data and, conversely, applied to the encoded data, reconstructs the original data.

This allows, on the one hand, exploiting the computing power of the electronic computer to make both the algorithm and the key increasingly complex and difficult to break, with a view to improving security.

On the other hand, the very fact that both the algorithm and the encoding/decoding key depend on a computer makes the security strength and level to depend, ultimately, on the computing power of the computer, which poses a background risk: it is likely that what was generated by a computer can be broken by a more powerful computer.

In other words, if a counterparty has computers with greater computing power, it will have a significant advantage, and with a certain level of probability (which could be considered unacceptable) it will discover not only the algorithm but also the encoding/decoding key, thus violating the security and secrecy of an encoding/decoding performed with computers having lower computing power.

Even more generally, the fact that the encoding/decoding key necessarily underlies a certain logic, being determined by a computer, makes it possible to violate the encoding if the creation logic of the encrypted text is known or discovered.

### SUMMARY OF THE INVENTION

In light of the foregoing, the need to have an encoding, transmission and/or storage and decoding method capable of improving performance in terms of security, secrecy and inviolability of data, mitigating or resolving the background drawbacks illustrated above is particularly felt.

Such an object is achieved by a method according to the claims.

This is the only “unbreakable” digital method, where “unbreakable” means inviolable, constructed, created, which offers the absolute maximum protection, without the two digital sequences, one containing the basic sequence and the other dedicated to determine the positions in the sequence, it is not possible to reconstruct the original message, by means of any computer and any system, because, being based on the transfer of only information of positions and a digital sequence taken from the real world or from digital sequences with the same essential features, so that the method operates, as those digitized from the real world, there is no way to reconstruct the original message without both sequences, because the basic sequence is always unique and new, so the mapping is always different and no decoding logic is applicable to identify keys that are not present or find occurrences to go back to the base generation algorithms to reconstruct the original text, because a logical algorithm was not used for generating the base, but a real moment only was mapped in digital format.

### BRIEF DESCRIPTION OF THE DRAWINGS

Further features and advantages of such a method will become apparent from the following description of preferred embodiment examples, made by way of a non-limiting example with reference to the accompanying figures, in which:

FIG. 1 shows an example of a digital sequence, in hexadecimal format, obtained by digitization by a digital camera after having taken, in an instant t1, a picture of the object depicted in FIG. 2;

FIG. 2 is an image depicting an object (detail of a sofa), as photographed at instant t1 by the camera (the digitization of this image is the sequence shown in FIG. 1);

FIG. 3 shows another example of a digital sequence, in hexadecimal format, obtained by digitization by a digital camera after having taken, in an instant t2 following t1, a photo of the object depicted in FIG. 4;

FIG. 4 is an image that depicts the same object of FIG. 2, but photographed in a subsequent instant t2 (the digitization of this image is the sequence shown in FIG. 3);

FIG. 5 shows a portion of the sequence shown in FIG. 1, chosen as a key digital sequence in an exemplary embodiment of the encoding method according to the invention.

### DETAILED DESCRIPTION OF THE INVENTION

A method for encoding, transmitting and/or storing and decoding digital information in a secure and unbreakable manner is described.

The method firstly comprises to provide a basic digital sequence, built on the basis of a total or partial digital reproduction of an object or of a real environment, or of a real event or phenomenon or of digital sequences with the same essential features, so that the method operates, as those digitized from the real world.

The aforesaid basic digital sequence is organized as a sequence of bit packets, in which each bit packet is characterized by a respective position in the sequence, in which each of the bit packets corresponds to an alphanumeric or special digital character of a given digital representation.

The method then provides for carrying out, by electronic processing means, an encoding of the digital information to be encoded, by means of an encoding process based on the above basic digital sequence, to obtain a respective positional information digital sequence, suitable to reconstruct the encoded digital information, if used in combination with the basic digital sequence.

The method then provides the steps of providing to one or more persons or devices or computers, to which one wishes to allow access to the encoded digital information, the above basic digital sequence and the above positional information digital sequence; and of carrying out, by electronic processing means, a decoding of the digital information received by a decoding process (corresponding to said encoding process), to obtain the respective encoded digital information.

The method provides that the encoding process is an encryption process comprising the steps of encoding the alphanumeric or special characters of the information to be encoded, based on a processing of the positions in which they are present, in the basic digital sequence, so that a subsequent processing of the positional information digital sequence indicates the way by which the alphanumeric or special characters of the information previously encoded, cab be reconstructed.

According to an embodiment of the method, the aforesaid step of sequentially encoding each of the alphanumeric or special characters of the information to be encoded comprises encoding each of the alphanumeric or special characters of the information to be encoded, by means of an encryption indicating the position in which the alphanumeric or special character to be encoded is located, according to a predetermined order of occurrence.

According to an implementation option, the above mentioned predetermined order of occurrence provides that the first time a character appears in the information to be encoded, it is encoded with the position in which such a character appears for the first time in the basic digital sequence, the second time that such a character appears in the information to be encoded it is encoded with the position in which such a character appears for the second time in the basic digital sequence, and so on according to the same criterion. This is only an option, the positions in the method can actually be managed in any manner, not necessarily linked to a continuous succession, as long as it is always possible to reconstruct the original data.

According to a further embodiment, the method further comprises the steps of generating the basic sequence so as to change the relative frequency of the occurrence of the alphanumeric or special characters, so as to make its use easier.

According to a particular embodiment of the method, the step of providing a basic digital sequence comprises: acquiring with any digital device a unique and random digital sequence from the real environment, or from a real event or phenomenon.

According to various possible implementation options, the step of constructing a basic digital sequence comprises: identifying as the basic digital sequence the same sequence of digital data corresponding to said digital representation; or identifying as a basic digital sequence a portion of said sequence of digital data corresponding to the digital representation.

According to an embodiment option of the method, the encoding process used in the step of performing an encoding comprises a data encryption method and/or a data cryptography method.

According to an implementation option of the method, the digital information to be encoded comprises a stream of digital data to be transmitted to a recipient.

According to an embodiment, the method further comprises the step of providing the above basic digital sequence to a sender.

In this case, the above mentioned step of encoding the digital information to be encoded is carried out by electronic processing means of the sender, to obtain the positional information digital sequence. The aforesaid step of providing the positional information digital sequence comprises transmitting, by the sender to a recipient, through data transmission means, the positional information digital sequence. The aforesaid step of providing the basic digital sequence comprises transmitting, by the sender to a recipient, through data transmission means, the basic digital sequence, independently and separately from the transmission of the positional information digital sequence. Finally, the aforesaid step of carrying out a decoding of the digital information received is performed by electronic processing means of the recipient, to which both the basic digital sequence and the positional information digital sequence are available.

According to another embodiment, the method further comprises the steps of storing the digital encoded information in a digital archive, and providing such a digital sequence to one or more persons, to whom one wishes to allow access to the encoded digital information.

According to a particular implementation option, the digital archive is a digital archive with shared access and/or accessible via cloud.

Implementation examples of a further method for encoding digital information by electronic processing will be described below.

The method provides to carry out an encoding of the digital information to be encoded by means of an encoding process using the processing of the positions of the basic sequence to obtain respective encoded digital information.

In an implementation example, the basic digital sequence can be stored on any medium.

According to different embodiments of the method, the encoding process used in the step of performing an encoding comprises a data encryption method and/or a data cryptography method.

In an embodiment, the step of carrying out an encoding comprises storing the information to be encrypted in a file to be encrypted, in the form of digital data to be encrypted; and then combining, using an encryption algorithm, the digitized data to be encrypted and the data of the key digital sequence to obtain an encrypted data file.

In a particular and important embodiment of the method, the information to be encoded comprises data organized in alphanumeric characters, and the encoding process is an encryption process.

According to this example, the method comprises the step of sequentially encoding each of the alphanumeric characters of the information to be encoded, by means of an encryption algorithm based on the key digital sequence.

According to an implementation variant, the method comprises, after the encoding of each alphanumeric character, the further step of modifying, according to a predefined modification criterion, the key digital sequence, so as to avoid repetitions in the encryption of successive equal alphanumeric characters.

In particular, according to an even more detailed implementation example, the key digital sequence comprises a sequence of bit packets belonging to a group of digital characters of a given digital format. The encoding process then comprises the further steps of bi-univocally associating each alphanumeric character to a respective digital character of the aforesaid digital format; and encoding each alphanumeric character of the information to be encoded on the basis of a position in which, in the digital key sequence, the digital character associated with the above alphanumeric character is present, according to a predefined position selection criterion.

For example, the digital format may be a hexadecimal format, or an octet format, or another format known per se.

In an embodiment of the method, the encoding step comprises encoding each alphanumeric character with an indication of the first position in which, in the digital key sequence, the digital character associated with such an alphanumeric character is present; and the above mentioned step of modifying comprises deleting the digital character of the key digital sequence whose position has determined the encoding of the newly encoded alphanumeric character.

In an embodiment of the method, the digital information to be encoded comprises a stream of digital data to be transmitted to a recipient.

In various application examples of the method, such digital data flow may comprise a digital file or electronic document of any kind. In fact, the present method may be applied to one or more digital files, having any format, any size and any content.

A method for encoding, transmitting and decoding digital information between a sender and a recipient according to the present invention is now described.

The method first of all comprises the step of providing a key digital sequence to both the sender and the recipient.

Such a key digital sequence is built on the basis of a total or partial digital reproduction of an object or of a real environment, or of a real event or phenomenon.

The method then provides for carrying out, by processing means of the sender, an encoding of the unencrypted digital information by means of an encoding method using the above key digital sequence as encoding key, to obtain respective encoded digital information.

The method then comprises the step of transmitting the encoded digital information to the recipient, by data transmission means.

Finally, the method provides for carrying out, by processing means of the recipient, a decoding of the digital information received by means of a dual decoding process with respect to the above encoding process, and using the above key digital sequence as the decoding key, to obtain the respective clear digital information.

The decoding step naturally provides a decoding algorithm (defined above as “dual”) corresponding to the encoding algorithm.

In this sense, different embodiments of the present method of encoding, transmitting and decoding digital information employ any of the encoding techniques mentioned above in the examples of the encoding method, and employ corresponding decoding techniques.

A method for encoding, storing, accessing and decoding digital information, also included in the present invention, is now described.

The method firstly provides for the step of providing a key digital sequence, built on the basis of a total or partial digital reproduction of an object or of a real environment, or of a real event or phenomenon.

The method then provides for carrying out, by electronic processing means, an encoding of the unencrypted digital information by means of an encoding method using the above key digital sequence as a basis for encoding, to obtain respective encoded digital information.

The method then comprises the steps of storing the digital encoded information in a digital archive; and then of providing the above digital sequence with the positions to one or more persons, to whom one wishes to allow access to the encoded digital information.

Finally, the method provides the step of carrying out, by processing means of the above one or more authorized persons, a decoding of the digital information received by means of a corresponding (i.e., dual) decoding process with respect to the above encoding process, and using the key digital sequence as the decoding key, to obtain the respective clear digital information.

According to an embodiment of each of the above mentioned methods, the digital reproduction comprises a sequence of digital data obtained by digitizing an acquired signal corresponding to the above real object or environment, or real event or phenomenon.

According to an implementation example of each of the above mentioned methods, the aforesaid acquired signal comprises an image or a video of a natural event or a surrounding environment, or of one or more objects present in a surrounding environment, or parts thereof.

A further embodiment of the method according to the invention is described in detail hereinafter, for purely descriptive and non-limiting purposes.

The method is used to encrypt and decrypt data transformed into digital format starting from digital sequences acquired from the real world.

Steps 1 and 2, described below, concerning the acquisition of the data to be encrypted and the acquisition of the basic sequence for encryption, may be performed in reverse order and carried out at different times.

### Step 1:

identifying, acquiring and storing (in any format) something existing in the real world, not generated by mathematical formulas, nor by algorithms nor by a computer;
if the acquisition is not directly in digital format, transforming the acquisition data into digital format by an appropriate means;
memorizing the digital acquisition thus performed, which represents a non-logical sequence of data acquired from the real world.

### Step 2:

acquiring the information to be encrypted by an appropriate means;
if the acquisition is not directly in digital format, transforming the data to be encrypted into digital format;
creating an encrypted file containing the information to be encrypted, by reclassifying the data of the digital sequence created from the real environment and acquired during step 1, using an encryption algorithm which combines the digitized data to be encrypted and the data of the above digital sequence acquired from the real world (digital natural sequence);
sending or transferring via the Internet or by any means, or by a physical device, to authorized persons, the file containing the digital sequence used for encryption;
sending or transferring the encrypted file via the Internet or by any means, or by a physical device (note that transfer of the encrypted file may be before or after the transfer of the digital sequence used for encryption).

### Step 3:

reading the file received containing the encrypted information and the file received with the natural digital sequence;
decrypting the information by an algorithm using both files, the file containing the encrypted information and the file containing the natural digital sequence used as a key, or basis for information encryption;
sending the decrypted information to a device to listen or view the information originally acquired and subsequently hidden.

With reference to FIGS. 1-4, further details on the “basic digital sequence” will be provided below, which, as already described, constitutes an important aspect of the methods of the present invention.

The use of these sequences as bases for encoding or encryption derives from the consideration that every object and every event existing in nature or in the world in which we live can be scanned and stored in a digital sequence. For this reason, the “basic digital sequence” is also defined in this description as a “natural digital sequence”, meaning by this definition any digital sequence created starting from the environment in which we live, or rather from the real world that surrounds us.

Natural digital sequences can become unique if the sequence is long enough, because the world we live in is constantly moving, every event that occurs is always the succession of another, but it is never completely the same as the previous one.

A natural digital sequence is the representation of something, in a specific period of time, in digital format.

It is possible to verify that two digital representations, for example images, even of the same object, acquired by an electronic acquisition means, are associated with very different digital sequences (natural digital sequences), each sufficiently detailed real event is unique and unrepeatable.

To illustrate this, FIG. 1 shows a part of a natural digital sequence generated by a digital camera, in hexadecimal format, following the taking of a photograph, at instant t1, of the object depicted in FIG. 2 (part of a sofa).

FIG. 3 shows the same part of the natural digital sequence generated at instant t2, following instant t1 of only 2 seconds, of the same object, in the same place, by the same digital camera.

It can be noted that the natural digital sequence of FIG. 3 is completely different from, and substantially completely unrelated to, the natural digital sequence of FIG. 1 (the result of an image acquisition occurred just 2 seconds before).

The natural digital sequence is completely different from the previous one, because at instant t2 something has changed, the light has changed, the object (shown at the instant t2 in FIG. 4), that is, the sofa, in some details is deteriorated, the filaments have been moved.

This shows that a very small change in the condition of the object, and therefore a minimal variation of the acquired digital image, is sufficient to create a completely different natural digital sequence.

For example, the natural digital sequence of each object or event depends on light, which is continuously and rapidly variable, so that each natural digital sequence at time 1+n (where n is a time interval) will always be different from those generated in previous moments.

According to another example, instead of an image one may capture a video, or a video clip, or an audio. For example, the natural digital sequence of a video clip may be of any length (even very large), depending on the length of the clip (which can also be very long). Typically, a two-hour video clip can generate a natural digital sequence of sizes ranging from 300 Megabytes to 15 Gigabytes, depending on the resolution, which can be stored.

A common property of these natural digital sequences is the fact that they can be generated from any digital device by extrapolating information from the world we live in.

Therefore, it is not possible to generate the same digital natural sequences (or to derive them in some way) by an algorithm or by a mathematical formula calculated with a computer or manually.

In fact, every natural digital sequence is a sort of “single shot” on a detail of the world that surrounds us, and does not derive from a formula, a logical rule, an algorithm, a calculation program.

Actually, there is no logic behind these sequences, or, rather, we do not know this logic, because in fact we are not able to accurately predict the evolution of what is happening in the environment around us.

Since no one can know and reconstruct the logic behind the generation of a digital natural sequence, it is possible to use these natural digital sequences to encode and/or encrypt and/or cipher any digital information before sending data everywhere and to anyone, via the Internet, mobile or any other digital tool. No computer is able to decrypt, because no computer can identify the logic with which the basic sequence was generated, since the latter is completely random and no computer can derive any data from the digital sequence containing the positions without the basic sequence. Except, of course, for a computer that has stored and can read both the basic digital sequence and the associated sequence containing the processing of the positions.

In this way, it is possible to send any information thus encoded on the Internet or on any digital medium without it being seen or read by someone until it is decrypted, or until the natural digital sequence used for the decoding is made public or provided.

With reference to FIG. 5, an encoding example is now described, purely by way of a non-limiting example.

FIG. 5 shows a portion of the natural digital sequence of FIG. 1, i.e. a particular sequence of hexadecimal characters, with a very high degree of uniqueness (one could say, perfectly random).

Now, if each of the alphabetic letters was previously mapped/associated with a respective character or hexadecimal number (or a packet of bits of other length) it is possible to carry out an encoding, for example, of positional type.

The word CASI can be encoded, letter by letter, as follows:
character C associated with the hexadecimal code F9, found for the first time in the natural digital sequence at position 5;
character A associated with the hexadecimal code 29, found for the first time in the natural digital sequence at position 13;
character S associated with the hexadecimal code 8E, found for the first time in the natural digital sequence at position 23;
character I associated with the hexadecimal code D6, found for the first time in the natural digital sequence at position 7.

Thus, the word CASI can be coded, in this example, as 5-13-23-7.

The encryption program will send this encoded data 5-13-23-7 to the receiving device, which knows or can access a copy of the same natural digital sequence, and is therefore able to proceed with the decryption of the information:
5 decrypted=F9=C
13 decrypted=29=A
23 decrypted=8E=S
7 decrypted=D6=I

The original file, containing the natural digital sequence, can be sent to the recipient by another means, for example manually, through a physical memory in a different period of time, so that the natural digital sequence cannot be intercepted together with the information.

In this way, the information thus encoded can be sent or shared via the Internet, telephone or in any other way, and cannot be decrypted by any computer unless the latter can access the natural digital sequence.

An implementation example of the method provides that, for the sake of security, no original position should be used more than once, in order to avoid cycles that could make the information decryptable.

As can be seen, the object of the present invention is fully achieved by the methods described above, by virtue of its functional and structural features.

Due to the use of the aforementioned “basic digital sequences”, or “natural digital sequences” as the basis for encryption, the encoding is practically inviolable by a computer, even with very high computing power.

In fact, computers in any case use logical algorithms and logical pseudo-random key generators to encrypt and decrypt information, and are unable to discover or violate a “key” based on a digital representation of a real object or event, digital representation that is not generated according to a logic that can be reconstructed by a computer.

In this way, it is possible to send any information thus encoded on the Internet or on any digital medium without it being seen or read by someone until it is decrypted, or until the natural digital sequence used for the encryption is made public or provided.

In other words, the main property of digital sequences, generated by acquiring data from the real world, is that of being constructed without any logic; each position is associated with data determined at the time of acquisition and the data contained can be reclassified by an encryption algorithm to hide information, in order to transfer securely all the information thus encrypted that can be exchanged by telephone, via Internet passing through various servers, in the cloud or anywhere.

The main difference compared to the traditional key-based encryption methods and algorithms, mostly known and often computer-decipherable, is that the file acquired from the real world does not have a known logical sequence, so any attempt to decrypt the information without the basic sequence that acts as a key is not feasible.

The method can now be performed quickly and effectively by current IT tools.

The above mentioned features, in turn, allow advantageously using the methods of the present invention in a very wide range of specific applications, as is apparent.

For example, it is possible to apply the methods of the invention to securely send any type of encrypted information, in any format, with any content, via the Internet, or mobile phone, or any other digital transmission means.

Furthermore, it is possible to use natural digital sequences to encrypt information stored in a cloud, or for confidential documents, for wills, for projects stored anywhere.

This information can be decrypted and read only by those who have the natural digital sequence, or if the author decides to make the natural digital sequence public.

In other words, the method, thanks to its features, is a method with very high security performance, and it is unbreakable, i.e., it offers the maximum possible protection, in the sense that, without the two digital sequences, one containing the basic sequence and the other one dedicated to determine the positions in the sequence, it is not possible to reconstruct the original message, with no computer and no system. This derives from the fact that the method is based on the transfer of only position information and a digital sequence taken from the real world, and there is no way to reconstruct the coded information without having both sequences, because the basic sequence is always unique and new, therefore the mapping is always different and no decoding logic is applicable to identify keys that are not present or find occurrences to go back to base generation algorithms to reconstruct the original text, because a logical algorithm was not used to generate the original base, but only a real moment in digital format has been mapped.

The present method, and the corresponding system that performs it, can therefore have a very important and advantageous impact in the areas in which it can be applied (for example in the context of all digital communications, telephone, via the Internet, at a global level), since it ensures total security during transmission, until the basic digital sequence and the sequence containing the processing of the positions are both available for the reconstruction of the originally mapped message.

A man skilled in the art may make several changes, adjustments, adaptations and replacements of elements with other functionally equivalent ones to the embodiments of the methods according to the invention in order to meet incidental needs, without departing from the scope of the following claims. Each of the features described as belonging to a possible embodiment can be obtained independently of the other embodiments described.

1. A method for encoding, transmitting or storing and decoding digital information in a secure and unbreakable manner, comprising the steps of:
providing a basic digital sequence, built on the basis of a total or partial digital reproduction of an object or of a real environment, or of a real event or phenomenon or of digital sequences with the same essential features, so that the method operates, as those digitized from the real world,
wherein the basic digital sequence is organized as a sequence of bit packets, in which each bit packet is characterized by a respective position in the sequence, in which each of the bit packets corresponds to an alphanumeric or special digital character of a given digital representation;
carrying out, by electronic processing means, an encoding of the digital information to be encoded, by means of an encoding process based on the basic digital sequence, to obtain a respective positional information digital sequence, suitable to reconstruct the encoded digital information, if used in combination with the basic digital sequence;
providing to one or more persons or devices or computers, to which one wishes to allow access to the encoded digital information, the basic digital sequence and said positional information digital sequence;
carrying out, by electronic processing means, a decoding of the digital information received by means of a decoding process corresponding to the encoding process, to obtain the respective encoded digital information;
wherein the encoding process is an encryption process comprising the steps of encoding the alphanumeric or special characters of the information to be encoded, based on a processing of the positions in which they are present, in the basic digital sequence, so that a subsequent processing of the positional information digital sequence indicates the way by which reconstructing the alphanumeric or special characters of the information previously encoded.

2. The method according to claim 1, wherein the step of sequentially encoding each of the alphanumeric or special characters of the information to be encoded comprises:
encoding each of the alphanumeric or special characters of the information to be encoded, by means of an encryption which indicates the position in which the alphanumeric or special character to be encoded is located, according to a predetermined order of occurrence.

3. The method according to claim 2, wherein the predetermined order of occurrence provides that a first time a character appears in the information to be encoded, it is encoded by means of the position in which the character appears for the first time in the basic digital sequence, a second time that the character appears in the information to be encoded it is encoded by means of the position in which the character appears for the second time in the basic digital sequence, and so on according to same criterion.

4. The method according to claim 1, further comprising the step of:
modifying the basic sequence obtained from the step of providing a basic digital sequence, by means of a predefined modification criterion, to change the relative frequency of the occurrence of the alphanumeric or special characters, so as to make it easier to use;
using the modified basic digital sequence as the basic digital sequence.

5. The method according to claim 1, wherein the step of providing a basic digital sequence comprises:
acquiring a signal representative of the real object or environment, or of the real event or phenomenon;
transforming the acquired signal, by means of a digitization operation, into a sequence of digital data which constitute a digital reproduction thereof;
generating the basic digital sequence on the basis of the sequence of digital data obtained by digitizing the acquired signal.

6. The method according to claim 1, wherein an acquisition step comprises acquiring a visual or sound signal representative of an object or an event.

7. The method according to claim 5, wherein the step of acquiring comprises acquiring an image or a video clip or an audio of a natural event or a surrounding environment, or of one or more objects present in a surrounding environment, or parts thereof.

8. The method according to claim 1, wherein the step of providing a basic digital sequence comprises:
providing a basic digital sequence, built on the basis of a total or partial digital reproduction of an object or of a real environment, or of a real event or phenomenon.

9. The method according to claim 1, wherein the step of providing a basic digital sequence comprises:
acquiring a signal from an analog or digital measurement instrument of a physical phenomenon or of an electrical signal in the time or frequency domain;
transforming the acquired signal, by means of a digitization operation, into a sequence of digital data which constitute a digital reproduction thereof;
generating the basic digital sequence on the basis of the sequence of digital data obtained by digitizing the acquired signal.

10. The method according to claim 5, wherein the step of constructing a basic digital sequence comprises:
identifying as a basic digital sequence the same sequence of digital data corresponding to the digital representation; or
identifying as a basic digital sequence a portion of the sequence of digital data corresponding to the digital representation.

11. The method according to claim 1, wherein the encoding process used in the step of performing an encoding comprises a data encryption method or a data cryptography method.

12. The method according to claim 1, wherein the digital information to be encoded comprises a stream of digital data to be transmitted to a recipient.

13. The method according to claim 1, further comprising providing to a sender the basic digital sequence, and wherein the step of performing an encoding of the digital information to be encoded is carried out by electronic processing apparatus of the sender, to obtain the digital sequence of positional information;
the step of providing the positional information digital sequence comprises transmitting, by the sender to a recipient, through data transmission equipment, the positional information digital sequence;
the step of providing the basic digital sequence comprises transmitting, by the sender to a recipient, through data transmission equipment, the basic digital sequence, independently and separately from the transmission of the positional information digital sequence;
the step of carrying out a decoding of the digital information received is performed by electronic processing equipment of the recipient, to which both the basic digital sequence and the digital sequence of positional information are available.

14. The method according to claim 1, further comprising
storing the encoded digital information in a digital archive;
providing to one or more persons to which one wishes to allow access to the encoded digital information, the basic digital sequence.

15. The method according to claim 14, wherein the digital archive is a digital archive with shared access or accessible via cloud.
